(19) United States
(12) Patent Application Publication
(10) Pub. No.: US 2018/0173807 A1
(43) Pub. Date: Jun. 21, 2018

(54) SYSTEM FOR MANAGING A WARDROBE

(71) Applicant: MASTERCARD INTERNATIONAL INCORPORATED, Purchase, NY (US)

(72) Inventors: Mayank Prakash, Dehradun (IN); Ashutosh Sharan, Gurgaon (IN); Nidhi Taneja, Dwarka (IN)

(21) Appl. No.: 15/386,667

(22) Filed: Dec. 21, 2016

(51) Int. Cl. G06F 17/30; H04W 76/02; G06K 7/10; H04W 4/12; G06F 3/0482

(52) U.S. Cl. CPC G06F 17/30867; G06F 17/30377; H04W 76/02; G06T 1/0007; H04W 4/12; G06F 3/0482; G06K 7/10554

(57) ABSTRACT

A system and method for managing a wardrobe that enables a user to manage various aspects of his/her wardrobe. For example, a user may enter new articles in his/her wardrobe that, once entered, comprise an article of the user's actual and virtual wardrobe. The user may also ask for recommendations for an article or outfit to wear to a particular event or on a particular day. The user may browse his/her wardrobe remotely, which can be a big help when shopping to avoid duplicate articles or to buy new articles that are complementary to articles already in the wardrobe. The user may also manage his/her wardrobe by keeping track of which articles of clothing have been removed and/or replaced.

### FIELD OF THE INVENTION

The present invention relates to managing the contents of a wardrobe such as, for example, a clothes wardrobe.

### BACKGROUND OF THE INVENTION

We spend a fair amount of time on our wardrobe, whether deciding what to wear today, or to an upcoming event or on vacation, what new clothes to buy, etc. Managing a clothes wardrobe likewise consumes our time. Current trends are for making more of what we do “smart.” Smart cars, smart phones, smart TVs, etc. Similarly, there have been efforts to make our clothes closets smart, see, e.g., U.S. patent application Ser. No. 14/687,487 filed on Apr. 15, 2015, the entire contents of which are incorporated herein.

Currently, we have different solutions available to suggest for us the type of food we should eat, the type of exercise we should do, the type of songs we should listen to and so on. All these solutions take into consideration our personal preferences along with other factors to improve our overall lifestyle and experience on daily basis. What is lacking, at least to date, is a smart way to explore and manage our wardrobe that also reduces the hassle to decide about the best dress for a particular day or event by providing suggestions based on personal preferences, current fashion trends and various other factors like weather, time of the day, type of occasion and so on.

Existing related solutions rely on limited SKU information to provide recommendation to the users. However, such solutions do not enable virtual browsing of via mobile device, for example. Nor do such solutions provide for image recognition, enabling a user to easily add new articles to his/her wardrobe.

Thus there exists a need for a solution to the above-identified shortcomings of the prior art.

### SUMMARY OF THE INVENTION

The present invention is directed to a system and method that achieves a technological solution to a technological problem specific to computer networks. The present invention utilizes a specific structure of various computer and computing components, devices and software communicating over a network to provide a user with remote access to his/her wardrobe, and with the ability to manage his/her wardrobe. As noted above, prior art options for managing a wardrobe rely on the limited SKU information available for an article of clothing. This information is not only limited in its content, it's also limited in how it can be used to enable a user to manage his/her wardrobe. It doesn't enable the user to browse his/her wardrobe, since it doesn't provide the ability of the user to identify articles in the wardrobe in accordance with embodiments of the present invention. It also doesn't enable the user to ask for help in picking articles from the wardrobe to wear for a particular day, event, etc. The present invention provides a system and method that includes components, devices and software that enable the user to identify an article of clothing from various types of inputs from the user. Advantageously, identifying in accordance with the present invention facilitates additional functionality and provides enhanced technological solutions for the user that are an advancement over the prior art.

The present invention enables a user to manage the content of his/her wardrobe. Using a user mobile device connectable to a server over a network, the present invention enables the user to identify new articles before being placed in the wardrobe, make recommendations for specific articles or outfits for a variety of circumstances (e.g., work, vacation, formal event, casual dinner, etc.), manage the contents of the wardrobe, and browse the contents remotely. The user mobile device has general and special purpose software installed and operational thereon, the special purpose software causing a processor of the mobile device to execute instructions to carry-out aspects of the present invention. The user mobile device connects over the network with a server having access to a plurality of databases, at least one of which contains a record for the wardrobe of each of a plurality of users, including a record for the user's wardrobe. The server also has general purpose and special purpose software installed and operational thereon—the special purpose software causing a processor of the server to execute instructions to carry-out aspects of the present invention. Other databases to which the server has access include, by way of illustration and not limitation, a weather database, a fashion trend database, a SKU database, a cashless transaction database (having records of cashless transactions), and others. The method of the present invention is carried out on the server through interaction with the user mobile device, at least one database, and other computing devices.

An embodiment of the present invention is directed to a system for managing the content of a user's wardrobe containing at least one article. The system comprises a user database containing a database record for the wardrobe of each of a plurality of users, including a database record for the user's wardrobe containing a plurality of record entries for a plurality of articles in the user's wardrobe. The system further comprises server having a processor operable by a program of instructions stored in memory. The server is connectable to a network and to a user mobile device, and the database is accessible by the server. The program of instructions, when executed by the server processor, causes the server processor to receive from the user mobile device a request to identify an article, receive from the user mobile device at least one characteristic of the article, receive from the user mobile device at least one image of the article, identify the article from at least one of the at least one characteristic and the at least one image, and create an entry in the database record for the user's wardrobe, the entry being based upon the identification of the article and comprising at least the at least one characteristic and the at least one image of the article. The at least one characteristic of the article received from the user mobile device comprises at least one of size, color, brand, material, type of article, purchase date and user supplied text.

The program of instructions of the present invention, when executed by the server processor, further causes the server processor to receive a request from the user mobile device to recommend at least one article or to browse a user's wardrobe, the request including at least one criteria, search the database record for the user's wardrobe for an article meeting the at least one criteria, determine if an article in the user's database meets the at least one criteria, and depending upon the result of the determination if an article in the user's database meets the at least one criteria, one of send to the user mobile device at least one of an image and information about at least one article in the user's database that meets the criteria, and determine if the user wants to send another request to recommend. The at least one criteria comprises at least one of day, event, weather, fays, color, holiday, type, vacation and fashion.

The program of instructions of the present invention, when executed by the server processor, further causes the server processor to receive from the user mobile device an input indicating that an article has been one of placed in and removed the user's wardrobe, identify the article that has been one of placed in and removed from the user's wardrobe, and update the user database to indicate that the article has been one of placed in and removed from the user's wardrobe.

The system of the present invention further comprises a user mobile device having a processor operable by a program of instructions stored in memory. The user mobile device is connectable to the network and to the server and has an image capture device, a display, and a user input device. The program of instructions stored in memory of the user mobile device, when executed by the user mobile device processor, causes the user mobile device processor to provide a graphical user interface to the display to receive input from the user. The input from the user causes the user mobile device processor to, at least one of capture at least one characteristic of an article in the user's wardrobe, send the at least one characteristic to the server capture at least one image of the article, send the at least one image of the article to the server, send a request to the server to recommend at least one article, receive from the server at least one of an image and information about at least one article in response to the request to recommend, send to the server an input indicating that an article has been one of placed in and removed from the user's wardrobe, and send a request to the server to browse the contents of the user's wardrobe, and receive from the server an image and information about at least one article in the user's wardrobe.

The program of instructions of the present invention, when executed by the server processor, further causes the server processor to receive from the user mobile device at least one characteristic of an article in the user's wardrobe further causes the server processor to receive one of a barcode scan and text entry from the user mobile device.

The program of instructions of the present invention stored in memory of the user mobile device, when executed by the user mobile device processor, further causes the user mobile device processor to send at least one characteristic of an article in the user's wardrobe and to at least one of scan a barcode and send the barcode scan to the server, and receive a text entry by the user and send the text entry to the server.

The program of instructions of the present invention, when executed by the server processor, further causes the server processor to receive from the user mobile device at least one image of the article in the user's wardrobe and further causes the server processor to receive from the user mobile device at least one image of the article captured by the image capture device.

The program of instructions of the present invention, when executed by the server processor, further causes the server processor to identify the article further causes the server processor to classify the article and compare the classification of the article with at least one other article in a reference database with the same classification.

The program of instructions of the present invention, when executed by the server processor, further causes the server processor to classify the article further causes the server processor to estimate an articulated pose of the clothing item of interest, segment the image of the article of interest, cluster the segments, and analyze the clustered segments to determine whether any of the clustered segments correspond to a clothing class.

In an embodiment of the present invention, the segments are clustered using Approximate Gaussian Mixture clustering.

The program of instructions of the present invention, when executed by the server processor, further causes the server processor to identify the article and further causes the server processor to compare one of the at least one characteristic with at least one entry in a reference database having a plurality of entries for a plurality of articles, and identify whether at least one of the at least one of the plurality of articles has the same characteristic as the at least one characteristic.

The program of instructions of the present invention, when executed by the server processor, further causes the server processor to receive from the user mobile device an input indicating that an article has been one of removed from and replaced in the user's wardrobe, identify the article that has been one of removed from and replaced, and update the user database to indicate the article has been one of removed and replaced, further causes the server processor to receive a signal from the user mobile device indicating that an article has been removed from the wardrobe, the signal containing an identifier for the article, wherein the server processor searches the database record for the user's wardrobe to determine if it contains the identifier for the article and, if it does, update that entry to indicate the article has been removed.

An alternate embodiment of the present invention is directed to a system for managing the content of a user's wardrobe. The system comprises a user database containing a database record for the wardrobe of each of a plurality of users, including a database record for the user's wardrobe containing a plurality of record entries for a plurality of articles in the user's wardrobe. The system further comprises a server having a processor operable by a program of instructions stored in memory. The server is connectable to a network and to a user mobile device, and the database is accessible by the server. The program of instructions, when executed by the server processor, causes the server processor to receive from the user mobile device a request to identify an article, receive from the user mobile device at least one characteristic of an article, receive from the user mobile device at least an image of the article, identify the article from at least one of the at least one characteristic and the at least an image, and create an entry in the database record for the user's wardrobe, the entry being based upon the identification of the article and comprising at least the at least one characteristic and the at least one image of the article. The system still further comprises a program of instructions stored in memory of a user mobile device and operable by a processor thereof. The user mobile device is connectable to the network and to the server and has an image capture device, a display, and a user input device. The program of instructions stored in memory of the user mobile device, when executed by the user mobile device processor, causes the user mobile device processor to provide a graphical user interface to the display to receive input from the user. The input from the user causing the user mobile device processor to, at least one of capture at least one characteristic of an article in the user's wardrobe, send the at least one characteristic to the server, capture at least one image of the article, send the at least one image of the article to the server, send a request to the server to recommend at least one article, receive from the server at least one of an image and information about at least one article in response to the request to recommend, send to the server an input indicating that an article has been one of placed in and removed from the user's wardrobe, and send a request to the server to browse the contents of the user's wardrobe, and receive from the server an image and information about at least one article in the user's wardrobe. The at least one characteristic comprises at least one of size, color, brand, material, type of article, purchase date and user supplied text.

The program of instructions of the present invention, when executed by the server processor, further causes the server processor to receive a request from the user mobile device to recommend at least one article or to browse a user's wardrobe, the request including at least one criteria, search the database record for the user's wardrobe for an article meeting the at least one criteria, determine if an article in the user's database meets the at least one criteria, and depending upon the result of the determination if an article in the user's database meets the at least one criteria, one of send to the user mobile device at least one of an image and information about at least one article in the user's database that meets the criteria, and determine if the user wants to send another request to recommend. The at least one criteria comprises at least one of day, event, weather, fays, color, holiday, type, vacation and fashion.

The program of instructions of the present invention, when executed by the server processor, further causes the server processor to receive from the user mobile device an input indicating that an article has been one of placed in and removed the user's wardrobe, identify the article that has been one of placed in and removed from the user's wardrobe, and update the user database to indicate that the article has been one of placed in and removed from the user's wardrobe.

The program of instructions of the present invention, when executed by the server processor, further causes the server processor to receive from the user mobile device at least one characteristic of an article in the user's wardrobe further causes the server processor to receive one of a barcode scan and text entry from the user mobile device.

The program of instructions of the present invention stored in memory of the user mobile device, when executed by the user mobile device processor, further causes the user mobile device processor to send at least one characteristic of an article in the user's wardrobe and to at least one of scan a barcode and send the barcode scan to the server, and receive a text entry by the user and send the text entry to the server.

The program of instructions of the present invention, when executed by the server processor, further causes the server processor to receive from the user mobile device at least one image of the article in the user's wardrobe further causes the server processor to receive from the user mobile device at least one image of the article captured by the image capture device.

The program of instructions of the present invention, when executed by the server processor, further causes the server processor to identify the article further causes the server processor to classify the article and compare the classification of the article with at least one other article in a reference database with the same classification.

The program of instructions of the present invention, when executed by the server processor, further causes the server processor to classify the article further causes the server processor to estimate an articulated pose of the clothing item of interest, segment the image of the article of interest, clusters the segments, and analyze the clustered segments to determine whether any of the clustered segments correspond to a clothing class.

In an embodiment of the present invention, the segments are clustered using Approximate Gaussian Mixture clustering.

The program of instructions of the present invention, when executed by the server processor, further causes the server processor to identify the article further causes the server processor to compare one of the at least one characteristic with at least one entry in a reference database having a plurality of entries for a plurality of articles, and identify whether at least one of the at least one of the plurality of articles has the same characteristic as the at least one characteristic.

The program of instructions of the present invention, when executed by the server processor casing causes the server processor to receive from the user mobile device an input indicating that an article has been one of removed from and replaced in the user's wardrobe, identify the article that has been one of removed from and replaced, and update the user database to indicate the article has been one of removed and replaced, further causes the server processor to receive a signal from the user mobile device indicating that an article has been removed from the wardrobe, the signal containing an identifier for the article, wherein the server processor searches the database record for the user's wardrobe to determine if it contains the identifier for the article and, if it does, update that entry to indicate the article has been removed.

An alternate embodiment of the present invention is directed to a method for managing the content of a user's wardrobe carried-out according to the inventive system described herein.

The present invention enables a user to identify and categorize articles of clothing in his/her wardrobe. The identified and categorized article is stored in a database entry of a wardrobe database for the user's wardrobe. Identifying comprises receiving from the user mobile device at least one characteristic of an article in the user's wardrobe. The at least one characteristic may be any descriptor of the article such as, by way of non-limiting example, size, color, brand, material (e.g., leather, suede, cotton, silk, etc.), type of article (e.g., shirt, blouse, pants, suit, dress, skirt, shoes, boots, etc.), purchase date, user supplied text (e.g., “A gift from my boss.”), or any other descriptive aspect of the article. Identifying further comprises receiving from the user mobile device an image of the article in the user's wardrobe. Preferably, a camera on the user mobile device is used to capture the image of the article, although a camera separate from the user mobile device may be used in addition to or instead of the camera on the user mobile device. Identifying still further comprises creating an entry in the database record for the wardrobe of the user for the article based upon identification of the article.

The present invention further enables a user to virtually browse his/her wardrobe, or to request recommendations for articles or outfits to wear based upon criteria entered by the user.

The present invention further enables the user to manage his/her wardrobe. More specifically, the present invention can track when an article or articles are removed from the wardrobe, when they're returned, how often they're worn, on what days/dates, and various other details of how a user utilizes their clothes and their wardrobe. This aspect of the present invention comprises receiving from the user mobile device an indicator that an article has been one of removed from and replaced in the user's wardrobe, and updating the user database to indicate the article has been one of removed and replaced. This aspect of the present invention can also keep track of the user's wardrobe “habits,” by tracking how often articles and outfits are worn and also by categorizing articles in the wardrobe based upon the usage such as, for example, every day clothes, work clothes, formal clothes, casual clothes, favorites, vacation, gifts, etc.

### DESCRIPTION OF THE DIAGRAMS

Embodiments of the present invention will now be described with reference to the following figures, wherein:

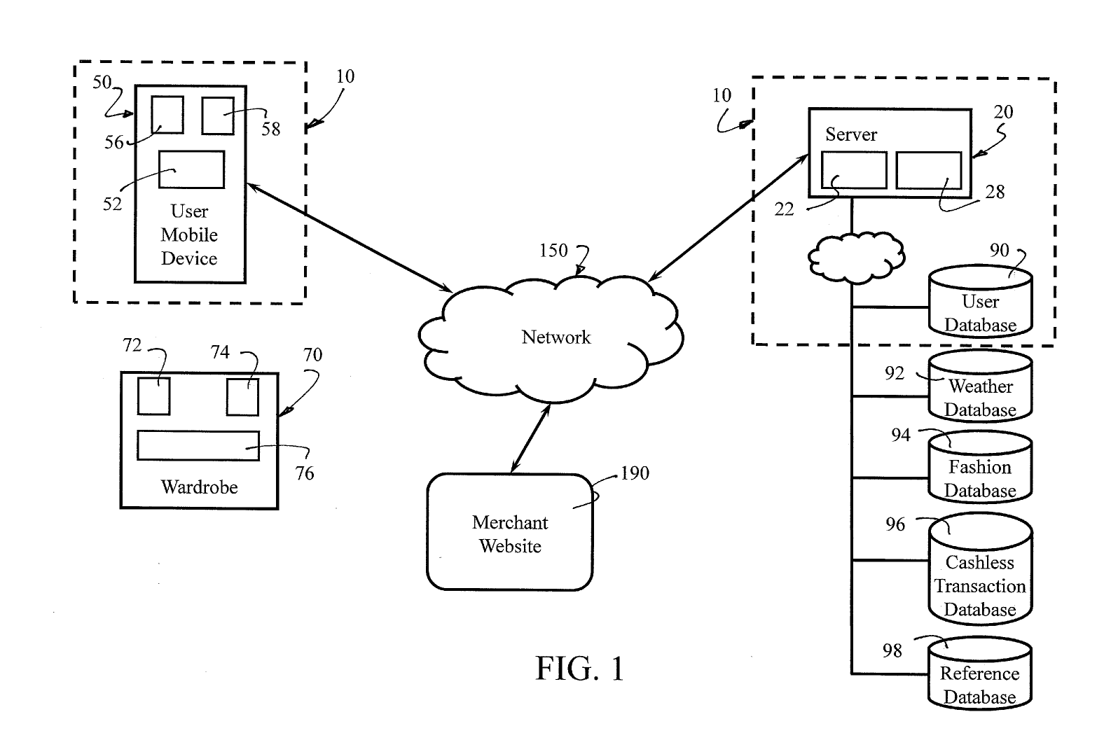

FIG. 1 depicts a system for managing a wardrobe, including certain devices and components configured in accordance with embodiments of the present invention;

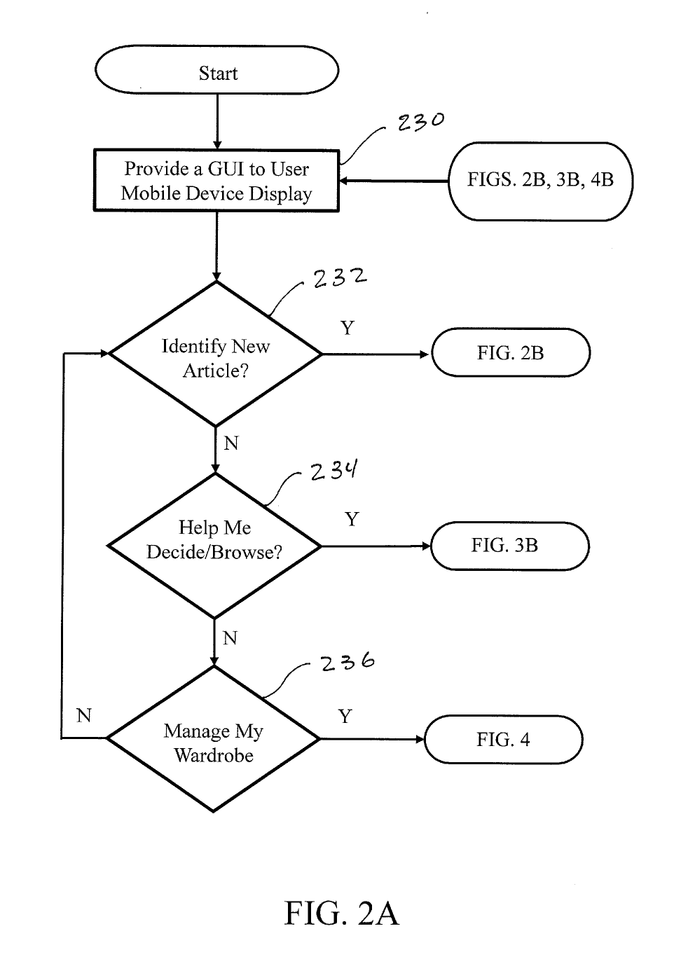

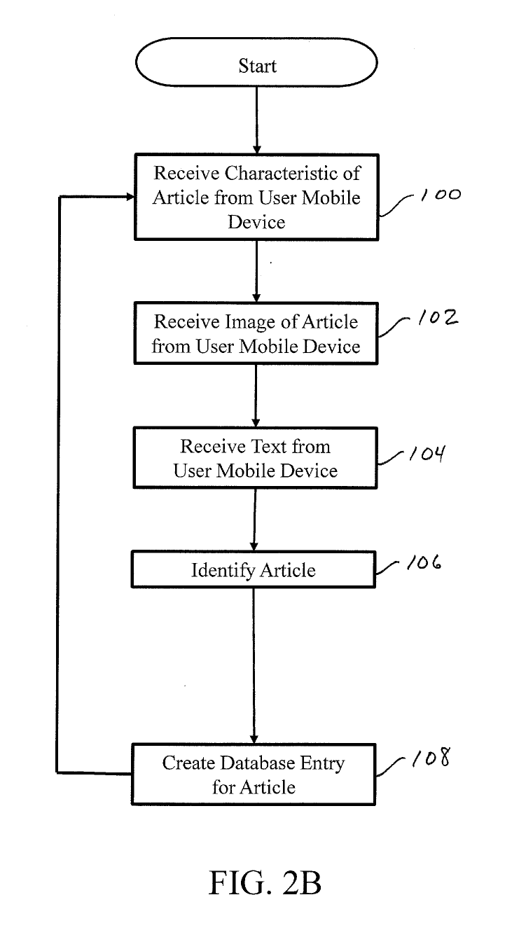

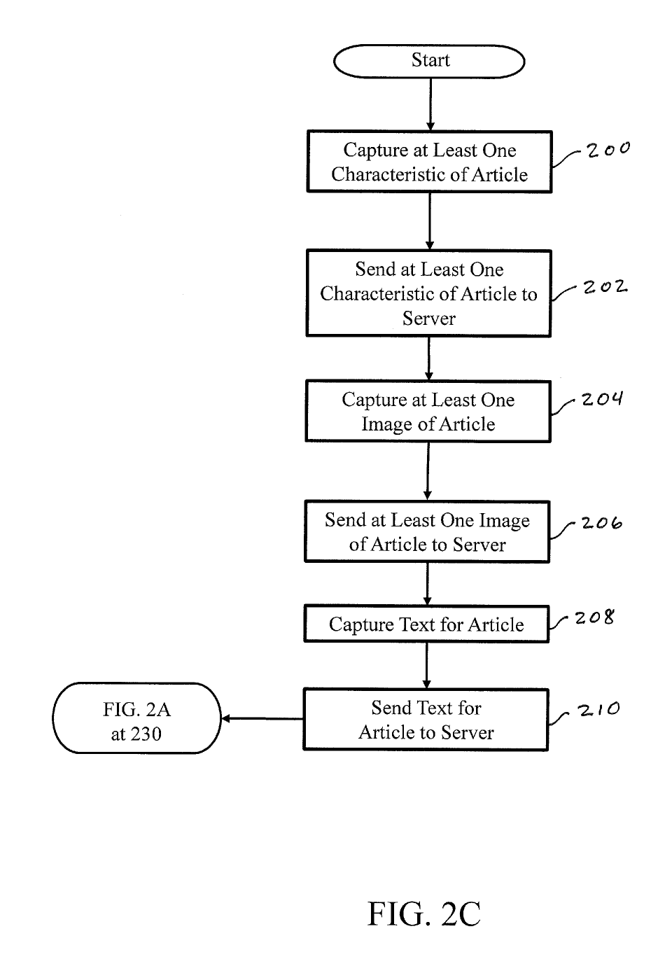

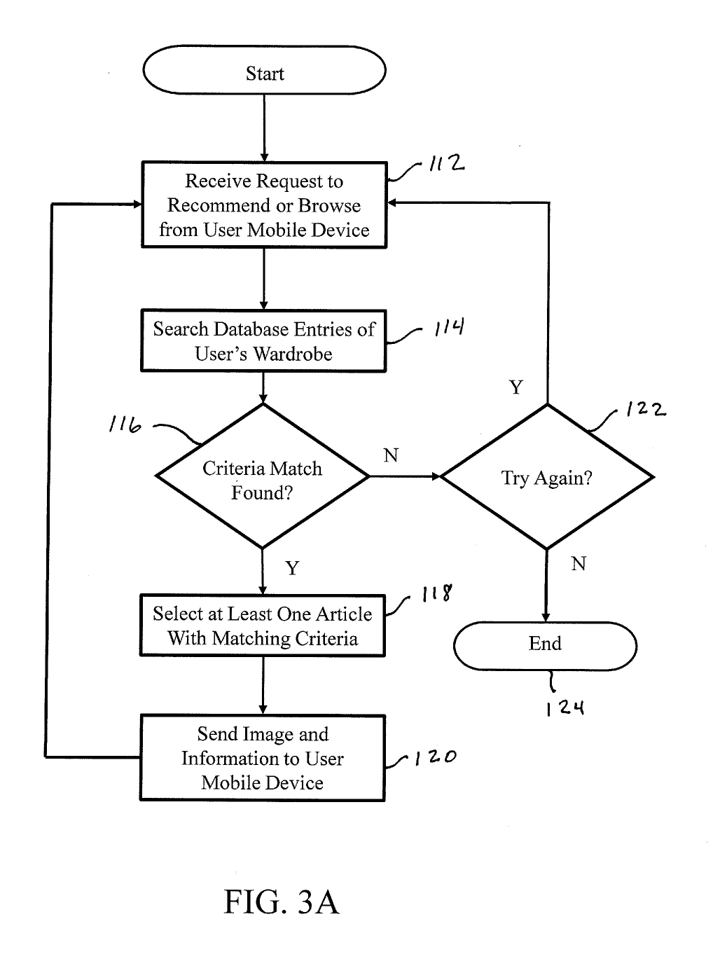

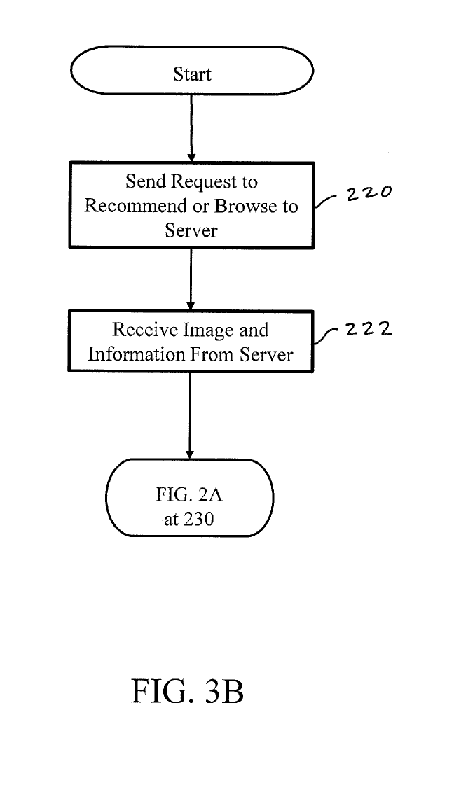

FIG. 2A is a flow diagram of options provided to a user via a graphical user interface displayed on a user mobile device in accordance with embodiments of the present invention;

FIG. 2B is a flow diagram of the process for identifying an article in a user's wardrobe carried out by a server in accordance with embodiments of the present invention;

FIG. 2C is a flow diagram of the process for identifying an article in a user's wardrobe carried out by a user mobile device in accordance with embodiments of the present invention;

FIG. 3A is a flow diagram of the process for recommending an article in a user's wardrobe or for browsing the contents of the user's wardrobe carried out by the server in accordance with embodiments of the present invention;

FIG. 3B is a flow diagram of the process for recommending an article in a user's wardrobe or for browsing the contents of the user's wardrobe carried out by the user mobile device in accordance with embodiments of the present invention;

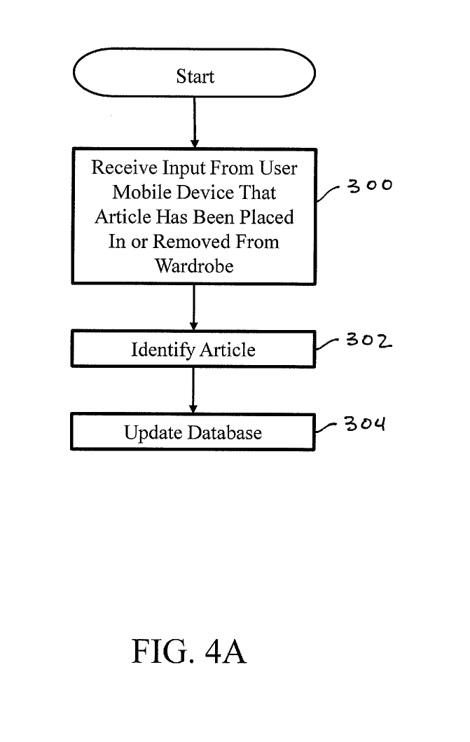

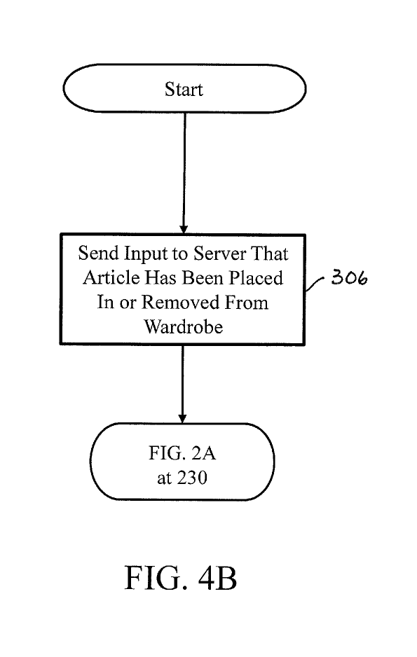

FIG. 4A is a flow diagram of the process for managing a user's wardrobe carried out by the server in accordance with embodiments of the present invention;

FIG. 4B is a flow diagram of the process for managing a user's wardrobe carried out by the user mobile device in accordance with embodiments of the present invention;

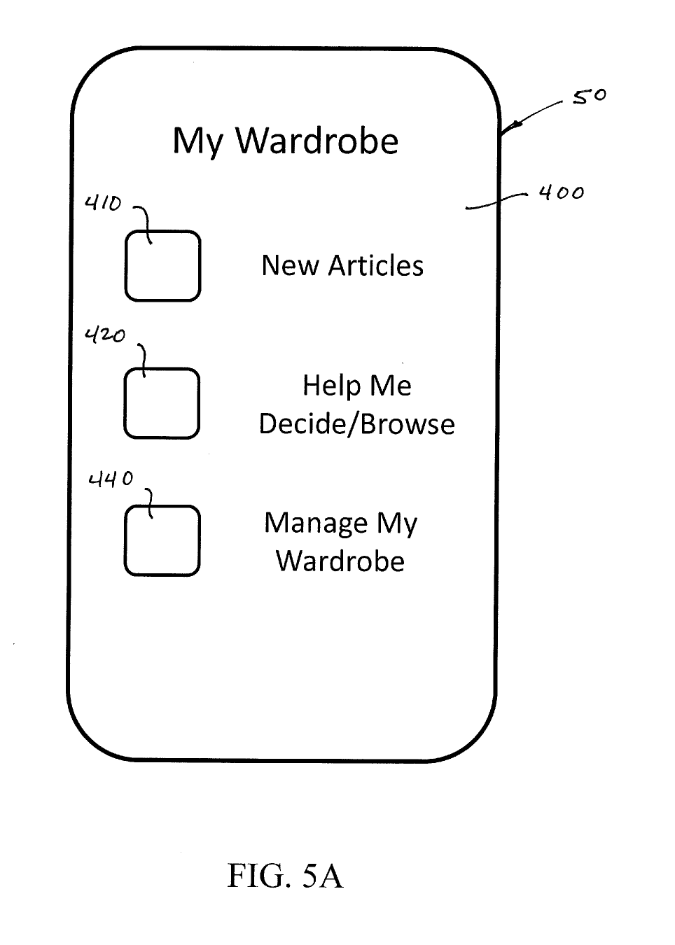

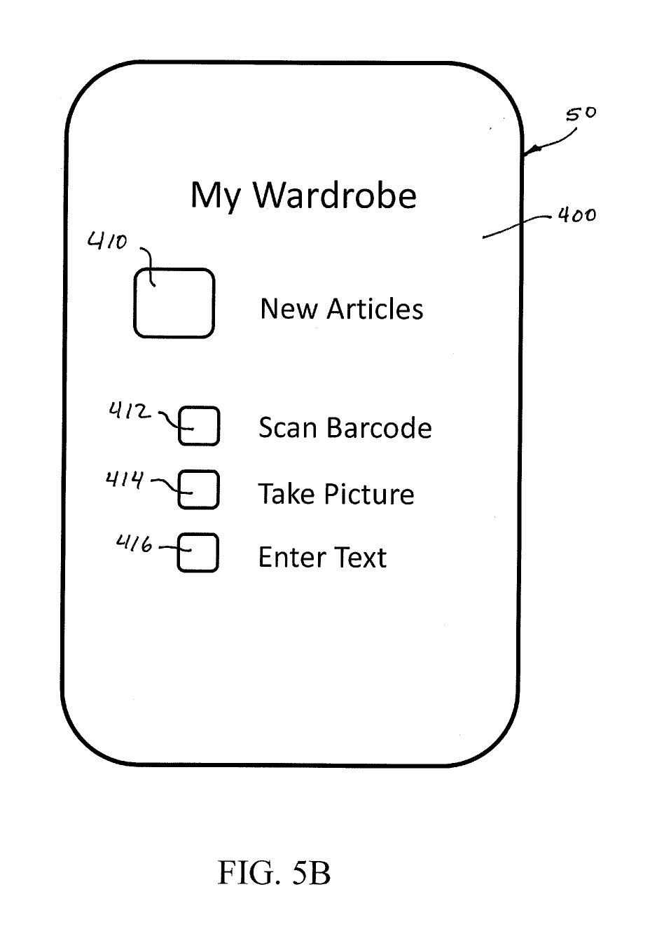

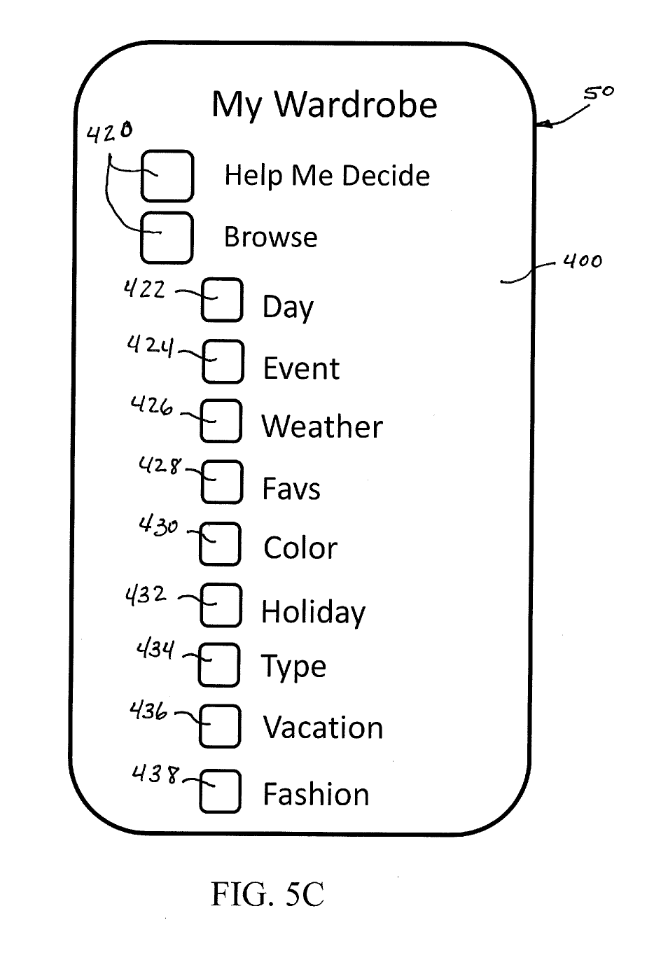

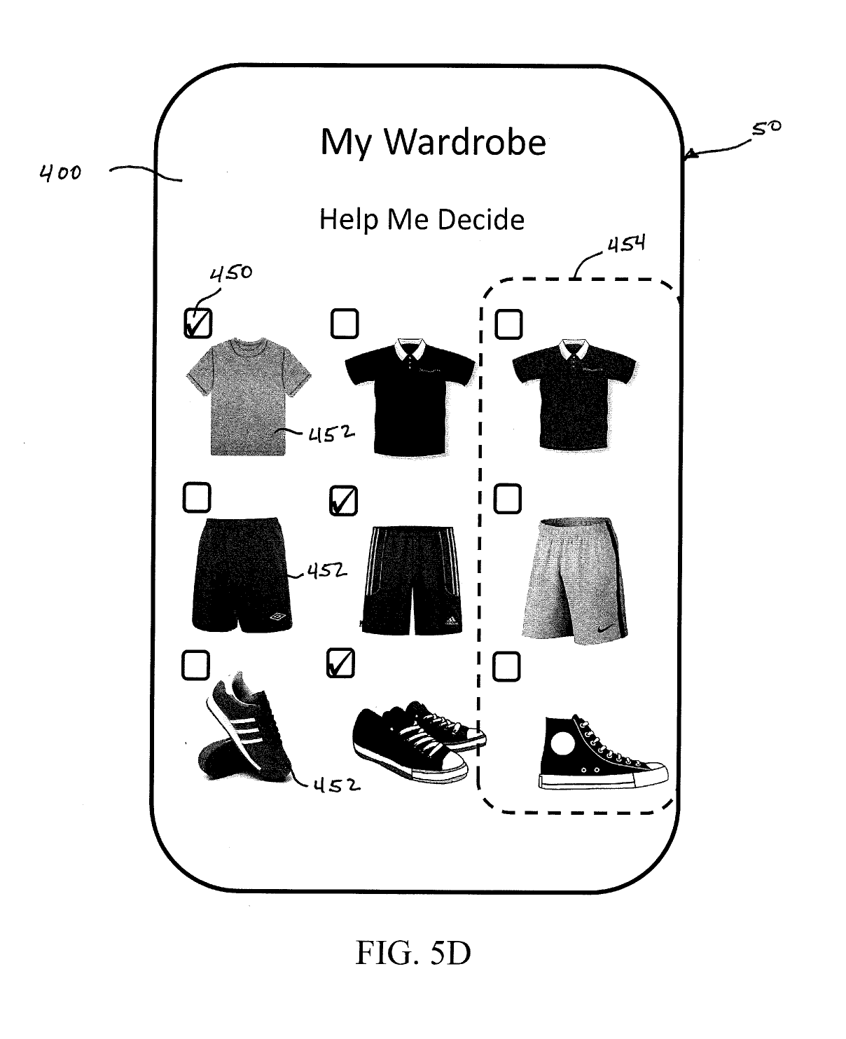

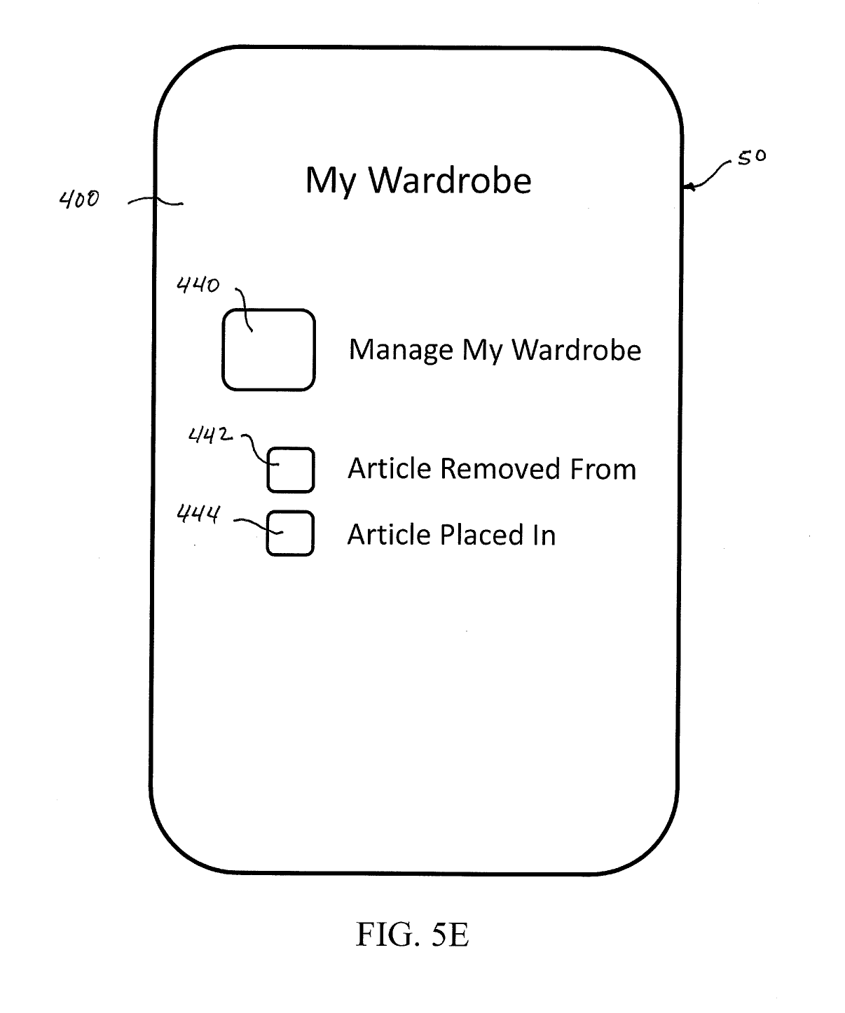

FIGS. 5A-5E depict various views of a graphical user interface provided by the special purpose software on the user mobile device displayed on the display of a user mobile device in accordance with embodiments of the present invention;

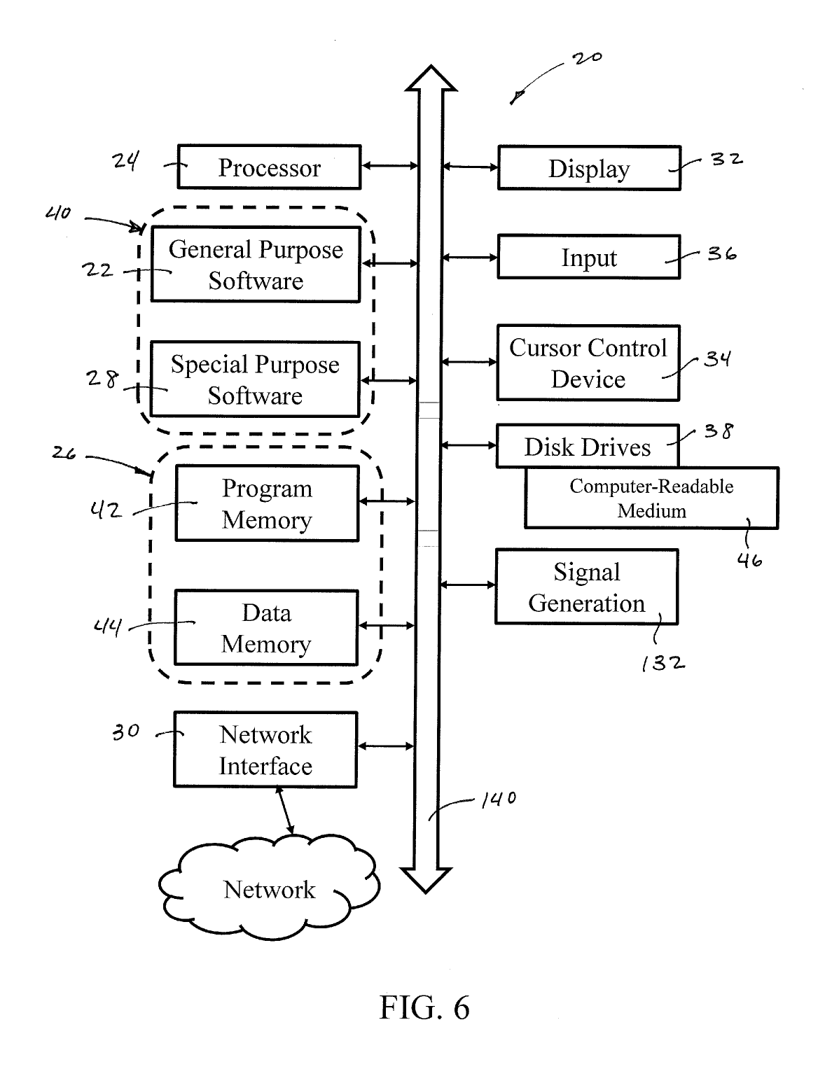

FIG. 6 is a block-diagram schematic of a server in accordance with embodiments of the present invention;

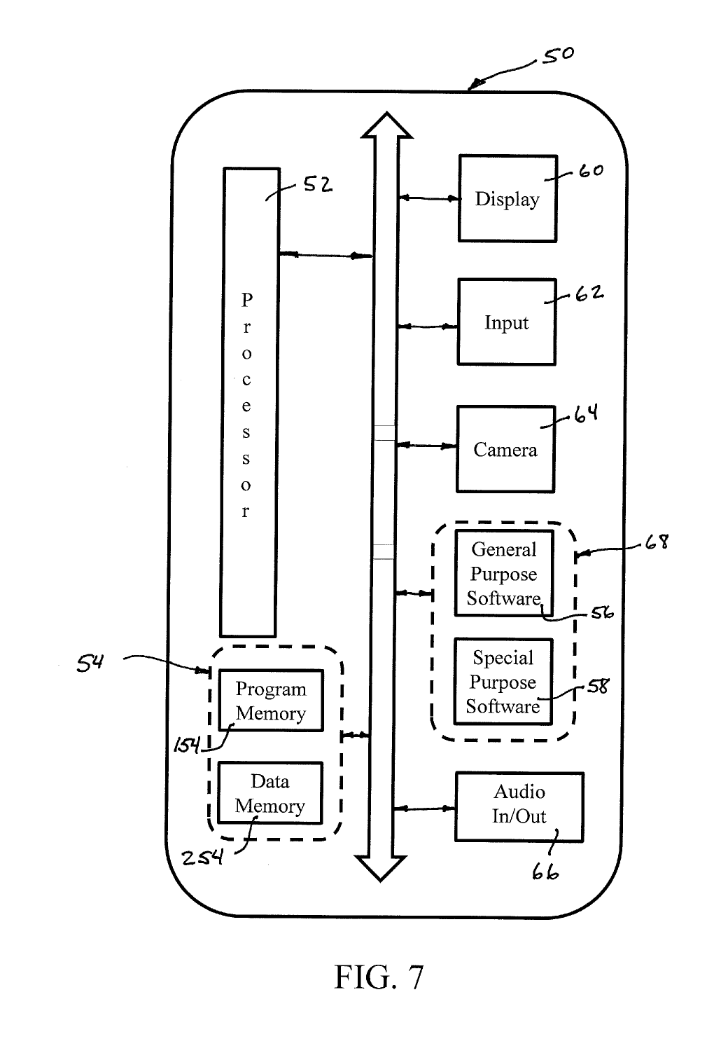

FIG. 7 is a block-diagram schematic of a user mobile device in accordance with embodiments of the present invention;

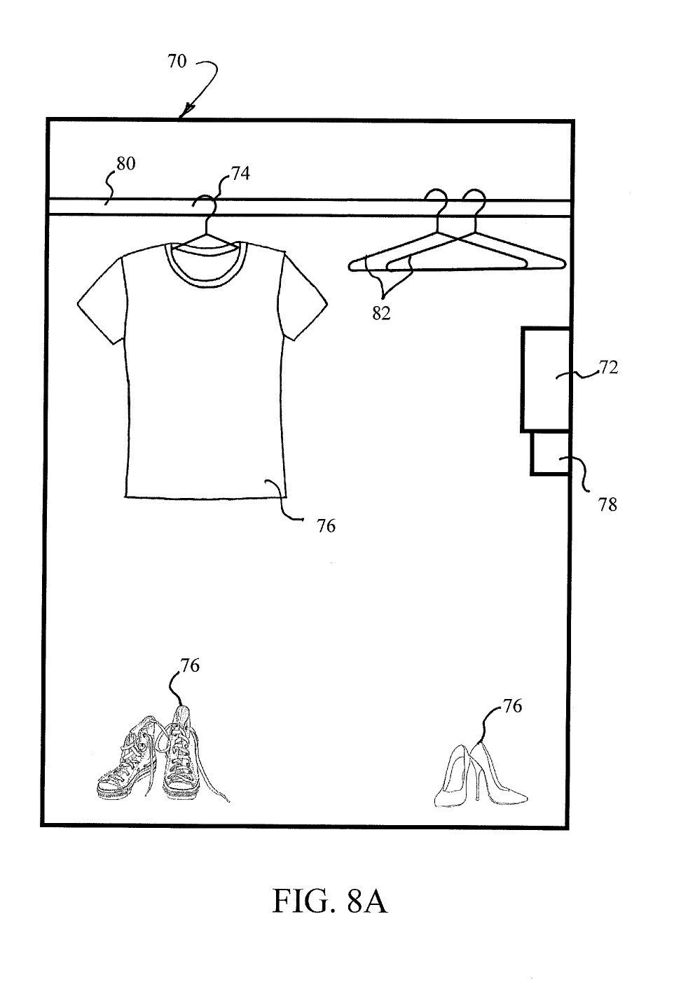

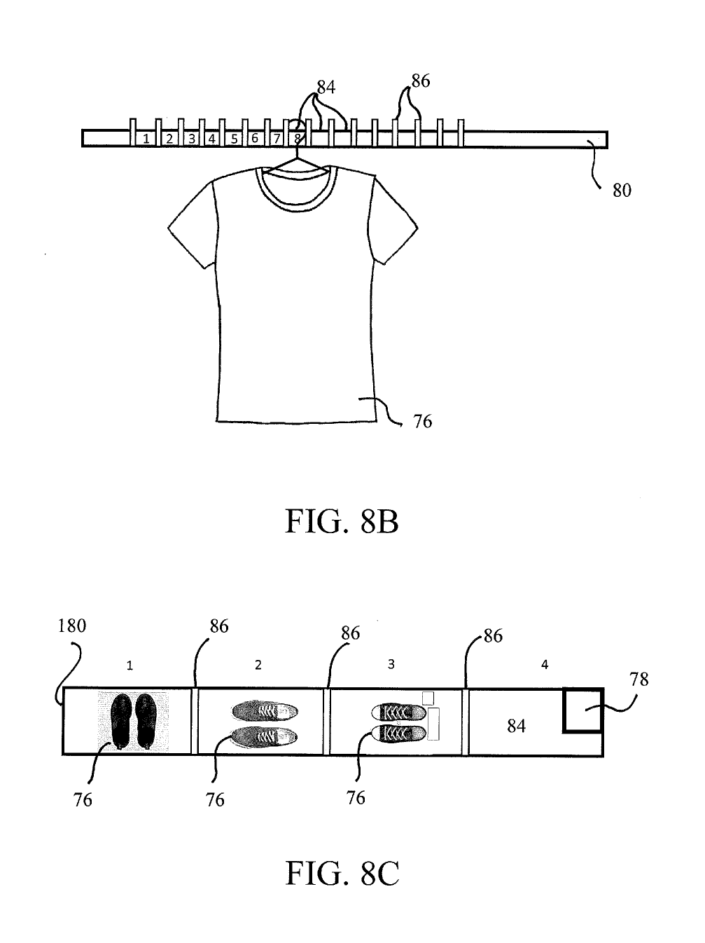

FIGS. 8A-8C depict a user's wardrobe in accordance with embodiments of the present invention;

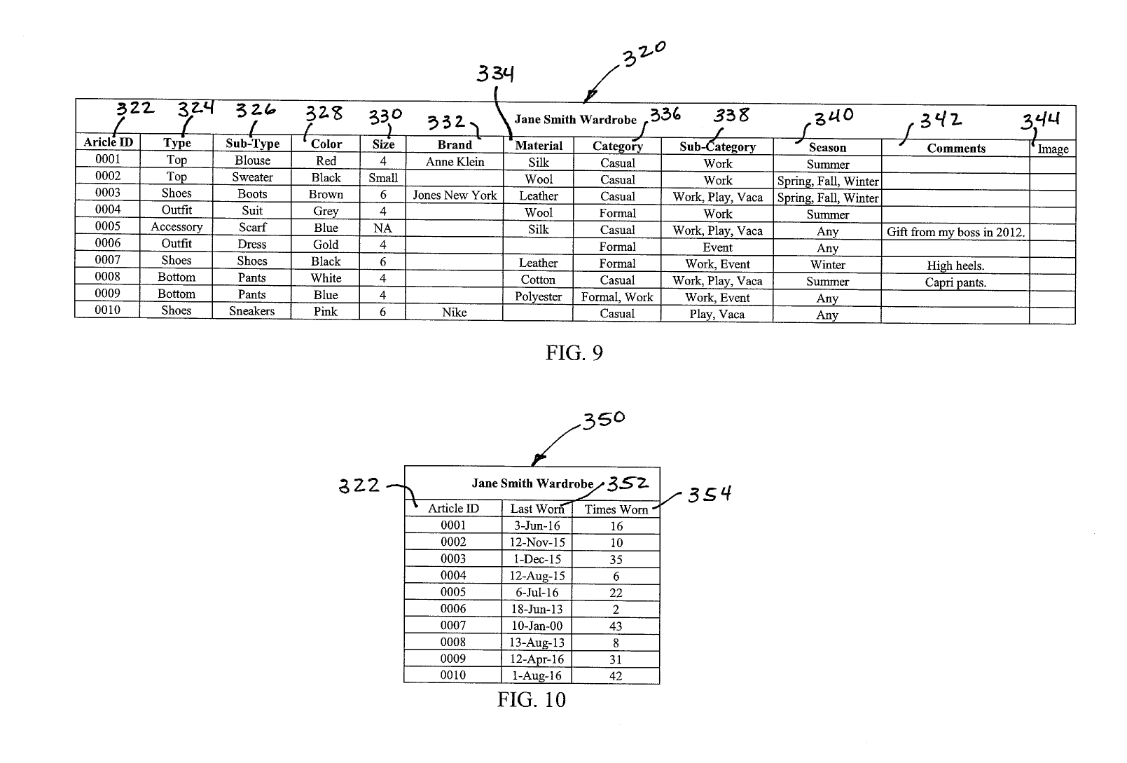

FIG. 9 is an illustrative example of a database record containing a plurality of entries for a plurality of articles of a user's wardrobe in accordance with embodiments of the present invention; and

FIG. 10 is an illustrative example of a database entry indicating certain usage information for articles in a user's wardrobe.

### DESCRIPTION OF EMBODIMENTS OF THE INVENTION

As used herein, the term “connectable” refers to various states of connection between electronic devices. For example, “connectable” refers to a physical connection between electronic devices, a wireless connection between electronic devices, a combination of a physical and wireless connection between electronic devices, a transient or episodic connection between electronic devices. As used herein the term “connectable” also refers to various states of connectivity between electronic devices such as, by way of non-limiting example, when electronic devices are not connected, when electronic devices are connecting, and when electronic devices are connected.

Referring next to the drawings in detail, embodiments of the present invention will now be discussed. In general, the system 10 of the present invention enables a user, using his/her mobile device, to manage the contents of his/her wardrobe more easily and efficiently. With special purpose software installed on a mobile device and on a server, a user can create a virtual copy of a wardrobe that is stored in a database accessible by the mobile device over a network and through the server.

Referring first to FIG. 1, an illustrative configuration of a system 10 in accordance with embodiments is depicted. The system 10 comprises a server 20 connectable to a network 150 that may be any known or hereafter developed network such as, by way of illustration and not limitation, a local area network (“LAN”), wireless network, cellular network, and variations and combinations thereof.

The server has installed and operational thereon general purpose software 22 to carry-out traditional functions of a server (see, e.g., discussion of FIG. 6, below), and special purpose software 28 to carry-out aspects of the present invention. The special purpose software 28 renders the server 20 a special purpose computing device insofar as the special purpose software 28 is operably controlling certain functions of the server 20 directed to the present invention.

The system 10 includes a user wardrobe database 90 containing separate database entries for wardrobes of a plurality of users, each database entry for each of the plurality of users containing entries for a plurality of articles of clothing 76 in each user's wardrobe (see, e.g., FIG. 9). Other databases are accessible by the server 20 in accordance with the present invention, including a weather database 92, a fashion database 94, a cashless transaction database 96, and a reference database 98—the forgoing representing illustrative, non-limiting examples, it being obvious to a person skilled in the art that other databases are contemplated by and within the scope and spirit of the present invention. The weather database 92 provides access to past, present and future forecast information about the weather at the user's location. The fashion database 94 provides access to information about fashion trends. The cashless transaction database 96 provides restricted access to information about cashless transactions carried-out by a plurality of users. The reference database 98 contains a plurality of entries for a plurality of reference articles, each entry being for a specific article or clothing and being accessible by the special purpose software 28 of the server 20 to identify an article of clothing in a user's wardrobe.

As used herein the term “cashless transaction” refers to a transaction between a user using a cashless transaction card, e.g., credit card, debit card, gift card, etc., a merchant, and an issuer of the cashless transaction card. The cashless transaction database 96 contains a plurality of database entries, each associated with a separate user, with each of the plurality of database entries containing records of a plurality of cashless transactions carried out by the user associated with the database entry. The server 20 is connectable to the user wardrobe database 90 and other databases via the network 150, another network (e.g., a LAN), or via direct connection to the server 20.

The system 10 of the present invention also comprises a user mobile device 50 such as, by way of non-limiting example, a cell phone, iPad, tablet, or any other now known or hereafter developed device that enables a user to send and receive information of any type over a wireless network. The user mobile device 50 is preferably a cell phone or smart phone, as discussed in more detail herein with reference to FIG. 7.

Also depicted in FIG. 1 is a merchant web site 190 to which a user can navigate using a user mobile device 50 or another computing device now known or hereafter developed. The user may browse and purchase items for sale by the merchant at the merchant website in any number of known ways. Based on the recommendations which a user gets from the innovations, user will also get an option to buy similar dresses from the merchant websites. For example, when the present invention recommends an article of clothing from the user's wardrobe, the special purpose software 28 on the server 20 provides the user with an option to browse one or more merchant websites 190 for similar or complementary articles of clothing. For example, if the present invention recommends a black dress from the user's wardrobe for a party, the present invention will also provide the user with an option to browse and buy a similar new dress or suitable accessory from the merchant's website. In an embodiment, the user will be provided with an option via the GUI 400 on his/her user mobile device 50 to navigate to the merchant website 190.

The system 10 of the present invention is operable over a network 150, preferably at least a part of which is a wireless network. The server 20 and user mobile device 50 are connectable to each other over the network 150, each carrying out aspects of the present invention as described in greater detail herein. The system 10 of the present invention enables a user to manage his/her wardrobe 70, performing various tasks and functions relating thereto as described herein.

With continued reference to FIG. 1, and additional reference to FIG. 6, a server 20 in accordance with embodiments of the present invention will now be discussed in more detail. The server 20 may be a general purpose computing device having a plurality of devices and components operably connected over a bus 140. The server 20 has one or more processors 24 or central processing units (“CPU”). Although the server 20 of the present invention is discussed as having a single processor 24, a server having multiple processor, either separate or integrated in a multi-core processor, for example, are also contemplated by and within the scope and spirit of the present invention. Reference to processor in the singular herein shall be interpreted to include any variation and number of processors. The processor 24 is operable by at least one program of instructions 40 comprising general purpose software 22 to carry out functions that enable the server 20 to interface with its various hardware components (discussed further below), and to interface and communicate with other devices. The processor 24 of the present invention is also operable by at least one program of instructions 40 comprising special purpose software 28 to carry out aspects of the present invention. The general purpose software 22 and special purpose software 28 may be stored on the server 20 in memory 26 that may comprise program memory 42 and data memory 44, or it may be stored on one or more disk drives 38 comprised of a computer-readable medium 46, or it may be stored in/on any combination of the foregoing. As used herein, the term “memory” is intended to include all currently known or hereafter developed types of permanent or temporary storage devices or components in a computing device. Exemplary memory types include, by way of illustration and not limitation, Random Access Memory (RAM)—further including Dynamic RAM (DRAM), Static RAM (SRAM), and Direct Rambus DRAM (DRDRAM), Read Only Memory (ROM)—further including Programmable ROM (PROM), erasable PROM (EPROM), and Electrically EPROM (EEPROM), cache memory, hard drives and flash memory.

The server 20 further includes a display 32 (e.g., liquid crystals display (LCD), a flat panel, a solid state display, or a cathode ray tube (CRT)), input device(s) 36 (e.g., a keyboard), cursor control device(s) 34 (e.g., a mouse), signal generation device(s) 132 (e.g., a speaker or remote control), and network interface device(s) 30 that enable the server 20 to selectively connect to and with a network 150 and send or receive voice, video or data, and to communicate over the network 150 as controlled by the program of instructions 40.

The memory 26 and disk drives 38 each comprise computer-readable medium 46 that may each include a single medium or multiple media (e.g., a centralized or distributed database, and/or associated caches and servers) that store the one or more sets of instructions 40. As used herein, the term “computer-readable medium” means and includes, but is not limited to, solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives that is considered a distribution medium equivalent to a tangible storage medium. Accordingly, the embodiment is considered to include anyone or more of a tangible computer-readable medium or a tangible distribution medium, as listed herein and including art-recognized equivalents and successor media, in which the software implementations herein are stored. The term “computer-readable medium” also means and includes any medium that is capable of storing, encoding, or carrying a set of instructions in the general purpose software 22 and in the special purpose software 28.

Although the present specification may describe components and functions implemented in the embodiments with reference to particular standards and protocols, the disclosed embodiments are not limited to such standards and protocols.

In accordance with various embodiments, the present invention may be implemented as one or more software programs running on one or more computing devices and one or more computer processors. Dedicated hardware implementations including, but not limited to, application specific integrated circuits, programmable logic arrays and other hardware devices can likewise be constructed to implement the present invention. Furthermore, alternative software implementations including, but not limited to, distributed processing or component/object distributed processing, parallel processing, or virtual machine processing can also be constructed to implement the present invention.

With continued reference to FIG. 1 and additional reference to FIG. 7, the server 20 is connectable to a user mobile device 50 such as, by way of non-limiting example, a cellular phone, tablet (e.g., iPad, iPad mini, etc.) via the network 150. For a cellular user mobile device 50, the connection between the server 20 and the user mobile device 50 is effected at least in part over a cellular network 150. The user mobile device 50 has installed and operational thereon a program of instructions 68 including general purpose software 56 and special purpose software 58. The general and special purpose software 58, 58 comprises a program or programs of instructions stored in memory 54 of the user mobile device 50 that, when executed by a processor 52 of the user mobile device 50, causes the processor 52 to carry-out aspects of the present invention. The general purpose software 56 and special purpose software 58 may be stored in memory 54 that may comprise program memory 154 and data memory 254. The special purpose software 58 may be an app downloadable from the server 20, or from another server that enables the download of apps to mobile devices.

The special purpose software 58 enables the user mobile device 50 to carry-out aspects of the present invention, and renders the user mobile device 50 a special purpose device insofar as the special purpose software 58 is operably controlling certain functions of the user mobile device 50.

The user mobile device 50 preferably includes a camera 64 or image capture device capable of capturing and storing in memory 54 an image. The camera 64 is also suitable for reading a barcode label, or capturing, recording, interpreting other objects. The user mobile device 50 also includes an input 62 that may comprise an alphanumeric keyboard or keypad, whether implemented as actual hardware or depicted on a display, that enables a user to enter alphanumeric information and to effect control of various aspects of the user mobile device 50. The user mobile device 50 also includes a display 60 via which information, images, graphical user interfaces, etc. are displayed to the user and accessible thereby. The display 60 may comprise a touch-screen by which a user may provide an input to the user mobile device 50 by touching the display 60 at the appropriate location, in which case at least certain aspects of the input 62 are provided via the display 60. The user mobile device 50 also includes an audio in/out 66 that enables sound to be input to and output from the device 50.

In use, the present invention enables a user to manage various aspects of his/her wardrobe. For example, a user may enter new articles in his/her wardrobe that, once entered, comprise an article of the user's actual and virtual wardrobe. Using the present invention, the user may ask for recommendations for an article or outfit to wear to a particular event or on a particular day. The user may browse his/her wardrobe remotely, which can be a big help when shopping to avoid duplicate articles or to buy new articles that are complementary to articles already in the wardrobe.

A user can access the present invention by first downloading the special purpose software 58, i.e., the app, to his/her mobile device 50. As part of a sign-up or registration process, the user may be prompted to enter certain personal information such as, for example, name, age, gender, address, etc. The special purpose software 58 may enable this through a graphical user interface (“GUI”) (not shown) provided on the user mobile device 50 or through linking to a social networking site (e.g., Facebook, etc.). Other ways of user registration or sign-up are also contemplated by, and within the scope and spirit of the present invention. Where sign-up or registration utilizes a social networking site, the user information may be obtained automatically from the user's account on that site. If a user does not wish to sign-up using his/her social networking account, the user can create a new account and provide relevant demographic information.

With continued reference to FIG. 1 and additional reference to FIGS. 8A-8C, a wardrobe 70 in accordance with embodiments of the present invention will now be discussed in detail. In some respects, the wardrobe 70 is typical in that it provides space and means for holding clothes. As used herein, the terms “clothes,” “clothing,” and variations thereof refer to any article or articles that may be worn. The wardrobe 70 may be provided in a closet, a piece of furniture, it may be free-standing (i.e., not defined by or contained within any enclosure), it may be partially enclosed, and there need not be any predefined structure or configuration, except for the aspects defined herein that are not typical of previously known wardrobes. Any configuration that facilitates holding clothes provides the typical aspects of a wardrobe 70. The wardrobe 70 contains a support 80 upon which clothes may be hung or supported by clothes hangers 82. The support 80 depicted in FIG. 8A comprises a bar or rod 80 that spans the width of the wardrobe 70 and that provides for hanging a plurality of hangers 82 and clothes 76. There are countless variations of the number, configuration, material, orientation, etc. of the support 80. For example, there may be multiple parallel supports 80 fully traversing the width of the wardrobe 70, multiple parallel supports 80 partially traversing the width of the wardrobe 70, multiple parallel supports 80 fully and partially traversing the width of the wardrobe 70, and may other variations of configurations of supports 80. Moreover, support 80 be may of any design and configuration, provided it provides the means to support clothes. Clothes 76 of any type hanging from hangers 82 of any type may be hung on the support 80. Clothes 76 include, by way of illustration and not limitation, shirts, pants, blouses, skirts, dresses, suits, sweaters, sweatshirts, jackets, coats, hats, belts, scarves, accessories of any type, shoes, sneakers, boots, gloves, bathing suits, gowns, and any other article that may be worn.

Certain aspects of the wardrobe 70 are unique. Specifically, a camera 72 is provided as part of the wardrobe 70 for facilitating certain aspects of the present invention. The camera 72 may be used by a user to identify new articles of clothing to be included in the wardrobe, as set forth in greater detail in FIGS. 2B and 2C. The camera 72 in the wardrobe 70 is capable of communicating with the user mobile device 50 and transmitting images thereto. Alternatively, a camera 64 on the user mobile device 50 may be used. At least one, and preferably a plurality, of sensors 74 are provided in the wardrobe 70. The sensors 74 are connectable with a transmitter 78 capable of communicating with the user mobile device 50 a status of each of the plurality of sensors 74. The sensors 74 detect when an article of clothing 76 is removed from or placed into the wardrobe 70 and can convey this condition to the user mobile device 50, where it may be received and interpreted by the special purpose software 58, and further communicated to the server 20, where it may be received and interpreted by the special purpose software 28. Sensor 74 may be any type of device capable of detecting a binary change in condition such as, by way of non-limiting example, on/off, present/not present, contact/no contact. Sensor 74 may be optical, electrical, electro-mechanical, proximity, radio-frequency (i.e., RFID), infrared, etc. For example, sensor 74 may comprise a first conductive part provided on each hanger 82 and a second conductive part 84 provided on the bar 80, as depicted in FIG. 8B. Preferably, a plurality of second conductive parts 84 are provided on the bar 80 separated by separators 86. This configuration defines a plurality of locations along the bar 80 that may be identifiably delineated so as to separate the bar 80 into a plurality of discrete locations, each of which may receive an article of clothes 76 on a hanger 82. The location at which an article 76 is hung may be provided as part of the process for identifying new articles (see, e.g., FIGS. 2B and 2C), and thereafter associated with that article 76. For example, as shown in FIGS. 8B and 8C, locations on the bar 80 and tray 180 have separators 86 that serve to delineate discrete locations (e.g., numbered 1, 2, 3, 4, etc.) for hanging or storing an article 76 in the wardrobe 70. When the first conductive part of a hanger 82 is in contact with the second conductive part 84 of the rod 80, the article 76 is in place in the wardrobe 70. When the conductive parts are not in contact with each other, the article 76 is not in place (i.e., is removed) in the wardrobe 70. That condition or change in condition is knowable by the special purpose software 28 on the server 20 and the special purpose software 58 on the user mobile device 50 through communication with the conductive part 84 and transmitter 78. When a change in condition occurs for an article 76, that change is communicated by the transmitter 78 to the user mobile device 50, the special purpose software 58 of which will query the user to confirm that the article 7 has been removed from the wardrobe 70 (or alternatively, placed in the wardrobe). Upon receipt of user confirmation, the user database record 320 will be updated and the user will see that particular article 76 indicated as “not in wardrobe” on the GUI 400 (described below) of the user mobile device 50 until the article 76 is placed back in the wardrobe, where the same process just described is followed. In this case, the user will be prompted to confirm that the article 76 has been placed back in the wardrobe 70, and the user database record 320 will again be updated to this change in condition (i.e., the “not in wardrobe” indicator will be removed).

A similar configuration of sensors may be provided for articles 76 that are not hung on hangers, as depicted in FIG. 8C. Here a tray 180 is configured to support a plurality of articles 76 such as shoes, boots, sneakers, etc., in a plurality of locations identifiably delineated by separators 86. The sensor 74 in this configuration may comprise a contact switch 84 that is in one state when an article 76 is in a location of the tray 180, and that is in another, different condition when the article 76 is not in the location of the tray 180. Other sensor types and configurations are possible, and are also within the scope and spirit of the present invention.

Referring next to FIG. 2A, the present invention enables a user to identify a new article in his/her wardrobe, request help in deciding what to wear, or browse his/her wardrobe, and manage his/her wardrobe. These options are depicted in FIG. 2A and are presented to a user via a GUI 400 on the display 60 of the user mobile device 50 (see, e.g., FIGS. 5A-5E, discussed in more detail below). At 230, the special purpose software 58 on the user mobile device 50 provides a GUI 400 to the display 60 of the user mobile device 50 on which the is presented three options: Identify a New Article at 232; Help Me Decide or Browse at 234; and Manage My Wardrobe at 236. The further aspects of each of these options is discussed in more detail below.

With reference next to FIGS. 2B and 2C, the system 10 of the present invention enables a user to identify articles in his/her wardrobe and create a virtual version of that wardrobe. FIG. 2B depicts a flow diagram of this aspect of the present invention as carried out by the special purpose software 28 on the server 20, and FIG. 2C depicts a flow diagram of this aspect as carried out by the special purpose software 58 on the user mobile device 50. In each case, the user first initiates the identifying aspect of the present invention by selecting that option via the GUI 400. This causes the special purpose software 58 to transmit a signal to the server 20 (and the server 20 to receive that signal) indicating that the user has selected this option. This also applies when a user selects one of the other options depicted in FIG. 2A. For example, when a user selects any one of Identify New Article 232, Help Me Decide/Browse 234, and Manage My Wardrobe 236, the special purpose software 58 of the user mobile device 50 will transmit a signal to the server 20 accordingly to initiate the respective aspect of the present invention. At 100, the special purpose software 28 on the server 20 receives from the user mobile device 50 at least one characteristic of an article in the user's wardrobe 70. The at least one characteristic may be any of size, color, brand, material, type of article (e.g., shirt, shoe, pants, dress, skirt, blouse, hat, belt, purse, etc.) that is captured by the user mobile device camera 64 or by the wardrobe camera 72 reading a barcode label having encoded therein SKU data and information. Alternatively, or in addition, the user may enter information via the input device 62 of the user mobile device 50. For example, the user may enter descriptive information such as that just listed, commentary (e.g., “Gift from my boss. 2012”), or any other type of information. At 102, the special purpose software 28 on the server 20 receives from the user mobile device 50 an image of the article that is captured by the camera 64 or the camera 72 in the wardrobe 70. At 104, the special purpose software 28 on the server 20 receives text from the user mobile device 50 entered by the user. From the characteristic, the image, and the text, the special purpose software 28 on the server 20 can, at 106, identify the article using known image recognition techniques and software by extracting attributes of the article such as color, design, pattern and shape.

In a preferred embodiment of the present invention, identification of an article via image recognition is accomplished with two main steps: classifying the clothing article of interest and comparing the classified article with a plurality of reference articles of clothing having similar classification and characteristics. Classification is done by first identifying the boundaries of a particular article by observing sharp change in the pixel values and thus obtaining an outline of the article. In this way only the article is used when identifying the article, and other aspects of the image that are not a part of the article (e.g., background, other articles, etc.) are not used for image recognition. Once the boundaries of an article are identified and an outline of the article is obtained, it can be compared with reference articles in the reference database 98 to identify the article type, e.g., shirt, pants, jacket, shoes, etc. The present invention may use a corner detection method such as “Harris Corner Detection” which helps in identifying boundaries of article in an image of more than the article (e.g., an image including background aspects of the image). Other now known or hereafter developed corner detection methods, or other detection methods, may be used by the present invention, and are contemplated by, and within its scope and spirit. For example, to identify a shirt as a shirt, the boundary of shirt in the image will be identified by a sharp change in the pixel values at the boundary. Once the boundary is identified, the image of the shirt or article is extracted from the rest of the image and is compared with by retrieving images from the reference database 98 and comparing the subject image with those retrieved from the reference database 98 to determine if there is a match. The reference database 98 may consist of different possible images of all the apparel types (like shirt, trouser and so on). The extracted image is compared with the images in the reference database 98 to classify the image into its specific article type. In this way, a shirt is identified and classified as a shirt, pants as pants, etc.

More specifically, image recognition in accordance with embodiments of the present invention first comprises a classification stage during which an image of an item of interest is classified, followed by a suggestion stage during which similar articles of clothing are suggested in an effort to identify and recognize the article of clothing of interest. During the classification stage, the present invention first estimates an articulated pose of the clothing item of interest (more typically, this occurs when image recognition is used for an article of clothing being worn by a person or on a mannequin, where it's important to know or to estimate the pose of the person or mannequin and account for that when attempting to identify the article of clothing). The present invention next segments the image of the article of interest by areas of the same or similar visual appearance, and clusters the segments using Approximate Gaussian Mixture clustering. Finally, the segments are analyzed to determine whether any of them correspond to a clothing class or classes.

Following the classification stage, image recognition according to embodiments of the present invention comprises a suggestion stage that considers visual features of the article of interest by capturing color and texture characteristics of the article. As part of this process, the present invention must accurately segment the region of the image of the article so that background information, i.e., information not directly relating to the article, is avoided or eliminated. To accomplish this the present invention utilizes a grabcut algorithm (see, e.g., C. Rother, V. Kolmogorov, and A. Blake. Grabcut: Interactive foreground extraction using iterated graph cuts. In TOG, volume 23, pages 309-314, 2004, the entire contents of which are hereby incorporated herein by reference). As further part of the suggestion stage, image recognition according to embodiments of the present invention creates and stores in memory 26 of the server 20 indexes per clothing class. This facilitates queries of only relevant clothing classes for a clothing region being classified, and yields query results that are visually very close to the article of interest. A further exemplary description of image recognition according to preferred embodiments of the present invention is provided in the publication, “Getting the Look: Clothing Recognition and Segmentation for Automatic Product Suggestions in Everyday Photos”, Kalantidis, Y., Kennedy, L., Li, L., ICMR ‘13, 2013, the entire contents of which are hereby incorporated herein by reference. It would be apparent to a person of ordinary skill in the art from that disclosure, the disclosure provided herein, and the knowledge of that person of skill, that variations to and modifications of image recognition in accordance with embodiments of the present invention are also contemplated by and with the scope and spirit of the present invention, the disclosure herein of which is intended to be illustrative and exemplary, and not limiting.

The special purpose software 28 on the server 20 can identify any article in a user's wardrobe using any or all of the characteristic, the image and the image recognition algorithm and software. Once the article is identified and categorized, the present invention creates, at 108, an entry in the database record for the user's wardrobe for that article (see, e.g., FIG. 9). Once an article has been identified and stored in the user's database, the present invention creates a virtual version of a user's wardrobe, enabling the user to search his/her virtual wardrobe using a variety of search criteria, ask for wardrobe recommendations, and further provides to the user a variety of clothing options in response to the user search criteria. These process of FIG. 2B may be repeated for any number of articles in the user's wardrobe.

Referring next to FIG. 2C, a flow diagram of the aspect of the present invention carried out by the user mobile device 50 that enables a user to identify articles in his/her wardrobe and create a virtual version of that wardrobe is depicted. Some of the steps in FIG. 2C correspond to steps shown in FIG. 2B. At 200, the user captures at least one characteristic of a new article for the wardrobe. The characteristic may be information obtained from a bar code on the article 76 using bar-code reading functionality of the user mobile device 50 and special purpose software 58. Once captured, the characteristic is sent to the server 20 at 202. The user can then capture at least one image of the article, at 204, using the camera 72 in the wardrobe or the camera 64 of the user mobile device 50. That image is sent to the server 20 at 206. The user can then enter text about the article, at 208, which is sent to the server 20 at 210. The text may be anything entered by the user.

With reference next to FIGS. 3A and 3B, the system 10 of the present invention can help a user to decide which article(s) in his/her wardrobe to wear on a particular day, to a particular event, etc., or enable the user to browse his/her wardrobe. FIG. 3A depicts a flow diagram of this aspect of the present invention as carried out by the special purpose software 28 on the server 20, and FIG. 3B depicts a flow diagram of this aspect as carried out by the special purpose software 58 on the user mobile device 50. At 112, the special purpose software 28 on the server 20 receives from the user mobile device 50 a request to recommend or to browse at least one article in the user's wardrobe for the user to wear. The request includes at least one criteria such as, by way of non-limiting example, a day, event, the weather, user favorites, color, holiday, vacation, type of article, etc. Other criteria usable to identify and categorize an article and/or outfit in a user's wardrobe are contemplated by and within the scope and spirit of the present invention. In response to a request to recommend, the special purpose software 28 on the server 20 will “assemble” outfits of articles in the wardrobe based upon the criteria selected by the user. Alternatively, in response to a request to browse, the special purpose software 28 provides images of articles in the user's wardrobe that meet the user-provided search criteria. At 114, the special purpose software 28 on the server 20 searches the database record of the user to determine if there is a record entry for at least one article in the database meeting the at least one criteria. At 116, the present invention determines if there is a match between the criteria entered by the user and an article in the user's wardrobe. If there is a match, the special purpose software 28 on the server 20 selects at least one article in the user's wardrobe that meets the criteria at 118, and sends an image and information to the user mobile device 50 of the at least one article at 120. If there is no match, the present invention queries the user whether he/she wants to try again, at 122. If the user responds in the affirmative, the process returns to 112. Alternatively, the process ends at 124.

Referring next to FIG. 3B, a flow diagram of the aspect of the present invention carried out by the user mobile device 50 that can help a user to decide which article(s) in his/her wardrobe to wear on a particular day, to a particular event, etc. is depicted. Some of the steps in FIG. 3B correspond to steps shown in FIG. 3A. When the user wants help selecting an article or an outfit from his/her wardrobe, he/she can ask the present invention to make a recommendation by sending a request to recommend or browse from the user mobile device 50 to the server 20 at 220. The request to recommend or to browse will contain certain criteria provided by the user that define and limit the articles in the user's wardrobe that may be suitable for satisfying the user's request. For example, the user may select any of day, event, weather, favorites, color, holiday, vacation, type, or various other criteria, the forgoing list being provided as illustrative, non-limiting examples. Other criteria not shown or discussed are also contemplated by and within the scope and spirit of the present invention. The user may select any one or a combination of these criteria and, at 220, special purpose software 58 on the user mobile device 50 sends the request with the criteria to the server 20. At 222, provided there is at least one item in the user's wardrobe that meets the criteria, the special purpose software 58 on the user mobile device 50 receives an image and information from the server 20 about the at least one article in the user's wardrobe.

With reference next to FIG. 4A, the system 10 of the present invention can help a user manage his/her wardrobe. FIG. 4A depicts a flow diagram of this aspect of the present invention as carried out by the special purpose software 28 on the server 20. At 300, the special purpose software 28 on the server 20 receives from the user mobile device 50 an input indicating that an article 76 has been either placed in or removed from the wardrobe 70. This input may be provided by one or more sensors 74 and/or the camera 72 in the wardrobe, or by input provided by the user using the input 62 or camera 64 of the user mobile device 50, for example. The input may comprise a change in condition detected by a sensor 74, as described herein and with reference to FIGS. 8A and 8B, or the input may comprise information entered by the user via the user mobile device 50. From the input received and at 300, the special purpose software 28 on the server 20 is able to identify the article 76 that has been placed in or removed from the wardrobe at 302, and then, at 304, update the user database accordingly.

With reference next to FIG. 4B, the managing aspect of the present invention provided by the user mobile device 50 is carried out by the special purpose software 58 sending an input to the server indicating that an article has been placed in or removed from the wardrobe at 306.

With continued reference to FIG. 2A, and additional reference to FIGS. 5A-5E, the GUI 400 provided on the user mobile device 50 will now be discussed in greater detail. The special purpose software 58 of the user mobile device 50 provides to the user the GUI 400 on the display 60 that provides a plurality of information to the user and enables a variety of functionality and control of the present invention. The GUI 400 presents the user with at least three options: New Articles 410; Help Me Decide/Browse 420; and Manage My Wardrobe 440. To identify an article, the user selects New Articles 410, and the special purpose software 58 on the user mobile device then presents via the GUI 400 shown in FIG. 5B further options for the user to identify the article including, by way of illustration and not limitation, Scan Barcode 412, Take Picture 414, and Enter Text 416. The user may select any or all of these in the process of identifying an article in his/her wardrobe. By selecting the Scan Barcode 412 option, the user is prompted by the special purpose software 58 to scan a barcode associated with the article the user wants to identify. The barcode scan can be accomplished using the user mobile device 50, its camera 64, and a generally available barcode capture and recognition application for the user mobile device 50. Once the user scans the barcode, the special purpose software 54 on the user mobile device 50 sends the scanned barcode information to the server 20.

Alternatively, or in addition, by selecting the Take Picture 414 option, the user is prompted by the special purpose software 58 to take at least one picture of the article the user wants to identify. The picture can be taken using the user mobile device camera 64 or a different camera such as, for example, a camera 72 in the user's wardrobe 70 (see, e.g., FIG. 8A). Once the user takes the picture, the special purpose software 54 on the user mobile device 50 sends the picture to the server 20. If the picture is taken using the camera 72 in the user's wardrobe 70, that picture may be sent to server 20 through the user mobile device 50, directly from the camera 72 for a network enabled camera, or through other known or hereafter developed methods and systems for transferring images.

Alternatively, or in addition, by selecting the Enter Text 416 option, the user is prompted by the special purpose software 58 to enter text via the input 62 of the user mobile device 50, the text providing descriptive information about the article the user wants to identify. Once the user enters the text, the special purpose software 54 on the user mobile device 50 sends the text to the server 20.

The system 10 of the present invention can help a user to decide which article(s) in his/her wardrobe to wear on a particular day, to a particular event, etc. The GUI 400 displayed by the special purpose software 58 in response to the user selecting the Help Me Decide/Browse 420 option for this aspect of the present invention is depicted in FIG. 5C. The user may enter any of a number of criteria to define the parameters for the desired wardrobe articles. For example, if the user selects Day 422 and then enters the day for which the user wants help, the special purpose software 28 determines if it is a work day or weekend day, searches the entries in the user's database record for articles that satisfy this criteria, i.e., articles suitable for work or for pleasure. If the user selects Weather 426, the special purpose software 58 on the user mobile device 50 determines the location of the user mobile device 50 using the global positioning system functionality of the that device—and consequently determines the location of the user—and sends that information to the special purpose software 28 on the server 20. The special purpose software 28 access a weather database 92 (see, e.g., FIG. 1) to determine the weather forecast for the user's location, and then searches entries in the user's database record for articles suitable for the forecasted weather. The user may select Event 424, and provide additional information about the type of event such, by way of non-limiting example, work, dinner, Theater, party (casual or formal), etc. The special purpose software 28 searches entries in the user's database record for articles suitable for the identified event, and similarly if the user selects Fays (favorites) 428, Color 430, Holiday 432, Vacation 434 and Type 436.

The present invention also enables a user to select an article or outfit based upon current fashion. The user selecting Fashion 438 causes the special purpose software 28 to access a fashion database 94 and retrieve information that may be used to identify articles in the user's wardrobe that are similar to the fashion database 94 articles. The fashion database 94 will consist of information related to all the articles which are currently in trend and popular among various segments of people. For example, a new design of blazer might have been introduced in the market which is becoming popular among the people of age of 25-35 years and is generally available only in grey or black color. If a user of the present invention is in that age bracket and personally likes grey and black color, the present invention will suggest the user to browse for new blazers on merchant websites.

In all cases, the special purpose software 28 searches the database entries for the users' wardrobe and sends to the user mobile device 50 at least one image and information about at least one article in the user's database in response to the user's request to Help Me Decide/Browse. The information and image are displayed on the display 60 of the user mobile device 50 as depicted in FIG. 5D, in which images for a plurality of articles 76 are shown and may be selected by the user to assemble an outfit. When the user has asked to browse his/her wardrobe, a plurality of images of articles in the user's wardrobe are still displayed via the display 60, but not arranged as outfits. Rather, the articles displayed may be arranged by type (e.g., shoes, shirts, pants, etc.), color, or other organizing criteria.

The system 10 of the present invention can also help a user manage his/her wardrobe. By selecting the Manage My Wardrobe 440 option, the special purpose software 28 on the server 20 receives from the user mobile device 50 an input indicating that an article 76 has been either placed in or removed from the wardrobe 70. As shown in FIG. 5E, the GUI 400 provides the user with two choices—Article Removed From 442 and Article Placed In 444. By the user's selection via the GUI 400, the special purpose software 58 on the user mobile device 50 sends to the special purpose software 28 on the server 20 an input that an article 76 has been placed in or removed from the wardrobe 70. The input received by the special purpose software 28 on the server 20 may be provided by one or more sensors 74, or by input provided by the user using the input 62 of the user mobile device 50, for example. The input may comprise a change in condition detected by a sensor 74, as described herein and with reference to FIGS. 8A and 8B, or the input may comprise information entered by the user via the user mobile device 50. From the input received from the user mobile device 50, the special purpose software 28 on the server 20 is able to identify the article 76 that has been placed in or removed from the wardrobe, and update the user database accordingly.

Referring next to FIGS. 9 and 10, illustrative examples of database records 320, 350 containing a plurality of entries for a plurality of articles of a user's wardrobe in accordance with an embodiment of the present invention are depicted. The example record 320 shown in FIG. 9 includes a plurality of information about each article including, by way of illustration and not limitation, an Article ID 322, Type 324, Sub-Type 326, Color 328, Size 330, Brand 332, Material 334, Category 336, Sub-Category 338, Season 340, Comments 342 and Image 344. This information is searchable by the special purpose software 26 on the server 20 when a user makes a Help Me Decide/Browse 420 selection.

The example record 350 shown in FIG. 10 includes information for each Article ID 322 (i.e., for each article) about when the article was Last Worn 352, and the number of Times Worn 354. This information is searchable by the special purpose software 26 on the server 20 when a user selects the Fays 428 option, for example.

Modifications to embodiments of the present invention are possible without departing from the scope of the invention as defined by the accompanying claims. Expressions such as “including,” “comprising,” “incorporating,” “consisting of,” “have,” “is,” used to describe and claim the present invention are intended to be construed in a non-exclusive manner, namely allowing for articles, components or elements not explicitly described herein also to be present. Reference to the singular is to be construed to relate to the plural, where applicable.

Although specific example embodiments have been described, it will be evident that various modifications and changes may be made to these embodiments without departing from the broader scope of the inventive subject matter described herein. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A system for managing the content of a user's wardrobe containing at least one article, the system comprising:
a user database containing a database record for the wardrobe of each of a plurality of users, including a database record for the user's wardrobe containing a plurality of record entries for a plurality of articles in the user's wardrobe; and
a server having a processor operable by a program of instructions stored in memory, the server being connectable to a network and to a user mobile device, the database being accessible by the server, the program of instructions, when executed by the server processor, causes the server processor to:
receive from the user mobile device a request to identify an article;
receive from the user mobile device at least one characteristic of the article;
receive from the user mobile device at least one image of the article;
identify the article from at least one of the at least one characteristic and the at least one image; and
create an entry in the database record for the user's wardrobe, the entry being based upon the identification of the article and comprising at least the at least one characteristic and the at least one image of the article.

2. A system according to claim 1, wherein the program of instructions stored in memory of the server, when executed by the server processor, further causes the server processor to:
receive a request from the user mobile device to recommend at least one article or to browse a user's wardrobe, the request including at least one criteria;
search the database record for the user's wardrobe for an article meeting the at least one criteria;
determine if an article in the user's database meets the at least one criteria; and
depending upon the result of the determination if an article in the user's database meets the at least one criteria, one of send to the user mobile device at least one of an image and information about at least one article in the user's database that meets the criteria, and determine if the user wants to send another request to recommend.

3. A system according to claim 1, wherein the program of instructions stored in memory of the server, when executed by the server processor, further causes the server processor to:
receive from the user mobile device an input indicating that an article has been one of placed in and removed from the user's wardrobe;
identify the article that has been one of placed in and removed from the user's wardrobe; and
update the user database to indicate that the article has been one of placed in and removed from the user's wardrobe.

4. A system according to claim 1, further comprising a user mobile device having a processor operable by a program of instructions stored in memory, the user mobile device being connectable to the network and to the server and having an image capture device, a display, and a user input device, the program of instructions stored in memory of the user mobile device, when executed by the user mobile device processor, causes the user mobile device processor to:
display a graphical user interface on the display to receive input from the user, the input from the user causing the user mobile device processor, at least one of:
capture at least one characteristic of an article in the user's wardrobe;
send the at least one characteristic to the server;
capture at least one image of the article;
send the at least one image of the article to the server;
send a request to the server to recommend at least one article;
receive from the server at least one of an image and information about at least one article in response to the request to recommend;
send to the server an input indicating that an article has been one of placed in and removed from the user's wardrobe; and
send a request to the server to browse the contents of the user's wardrobe, and receive from the server an image and information about at least one article in the user's wardrobe.

5. A system according to claim 1, wherein the program of instructions stored in memory of the server causing the server processor to receive from the user mobile device at least one characteristic of an article in the user's wardrobe further causes the server processor to receive one of a barcode scan and text entry from the user mobile device.

6. A system according to claim 4, wherein the program of instructions stored in memory of the user mobile device causing the user mobile device processor to send at least one characteristic of an article in the user's wardrobe and to at least one of scan a barcode and send the barcode scan to the server, and receive a text entry by the user and send the text entry to the server.

7. A system according to claim 4, wherein the program of instructions stored in memory of the server causing the server processor to receive from the user mobile device at least one image of the article in the user's wardrobe further causes the server processor to receive from the user mobile device at least one image of the article captured by the image capture device.

8. A system according to claim 1, wherein the program of instructions stored in memory of the server causing the server processor to identify the article further causes the server processor to classify the article and compare the classification of the article with at least one other article in a reference database with the same classification.

9. A system according to claim 8, wherein the program of instructions stored in memory of the server causing the server processor to classify the article further causes the server processor to estimate an articulated pose of the clothing item of interest, segment the image of the article of interest, cluster the segments, and analyze the clustered segments to determine whether any of the clustered segments correspond to a clothing class.

10. A system according to claim 9, wherein the segments are clustered using Approximate Gaussian Mixture clustering.

11. A system according to claim 1, wherein the at least one characteristic comprises at least one of size, color, brand, material, type of article, purchase date and user supplied text.

12. A system according to claim 1, wherein the program of instructions stored in memory of the server causing the server processor to identify the article further causes the server processor to compare one of the at least one characteristic with at least one entry in a reference database having a plurality of entries for a plurality of articles, and identify whether at least one of the at least one of the plurality of articles has the same characteristic as the at least one characteristic.

13. A system according to claim 2, wherein the at least one criteria comprises at least one of day, event, weather, fays, color, holiday, type, vacation and fashion.

14. A system according to claim 3, wherein the program of instructions stored in memory of the server causing the server processor to receive from the user mobile device an input indicating that an article has been one of removed from and replaced in the user's wardrobe, identify the article that has been one of removed from and replaced, and update the user database to indicate the article has been one of removed and replaced, further causes the server processor to receive a signal from the user mobile device indicating that an article has been removed from the wardrobe, the signal containing an identifier for the article, wherein the server processor searches the database record for the user's wardrobe to determine if it contains the identifier for the article and, if it does, update that entry to indicate the article has been removed.

15. A system for managing the content of a user's wardrobe containing at least one article, the system comprising:
a user database containing a database record for the wardrobe of each of a plurality of users, including a database record for the user's wardrobe containing a plurality of record entries for a plurality of articles in the user's wardrobe;
a server having a processor operable by a program of instructions stored in memory, the server being connectable to a network and to a user mobile device, the database being accessible by the server, the program of instructions, when executed by the server processor, causes the server processor to:
receive from the user mobile device a request to identify an article;
receive from the user mobile device at least one characteristic of an article;
receive from the user mobile device at least an image of the article;
identify the article from at least one of the at least one characteristic and the at least an image; and
create an entry in the database record for the user's wardrobe, the entry being based upon the identification of the article and comprising at least the at least one characteristic and the at least one image of the article; and
a program of instructions stored in memory of a user mobile device and operable by a processor thereof, the user mobile device being connectable to the network and to the server and having an image capture device, a display, and a user input device, the program of instructions stored in memory of the user mobile device, when executed by the user mobile device processor, causes the user mobile device processor to:
display a graphical user interface on the display to receive input from the user, the input from the user causing the user mobile device processor, at least one of:
capture at least one characteristic of an article in the user's wardrobe;
send the at least one characteristic to the server;
capture at least one image of the article;
send the at least one image of the article to the server;
send a request to the server to recommend at least one article;
receive from the server at least one of an image and information about at least one article in response to the request to recommend;
send to the server an input indicating that an article has been one of placed in and removed from the user's wardrobe; and
send a request to the server to browse the contents of the user's wardrobe, and receive from the server an image and information about at least one article in the user's wardrobe.

16. A system according to claim 15, wherein the program of instructions stored in memory of the server, when executed by the server processor, further causes the server processor to:
receive a request from the user mobile device to recommend at least one article or to browse a user's wardrobe, the request including at least one criteria;
search the database record for the user's wardrobe for an article meeting the at least one criteria;
determine if an article in the user's database meets the at least one criteria; and
depending upon the result of the determination if an article in the user's database meets the at least one criteria, one of send to the user mobile device at least one of an image and information about at least one article in the user's database that meets the criteria, and determine if the user wants to send another request to recommend.

17. A system according to claim 15, wherein the program of instructions stored in memory of the server, when executed by the server processor, further causes the server processor to:
receive from the user mobile device an input indicating that an article has been one of placed in and removed from the user's wardrobe;
identify the article that has been one of placed in and removed from the user's wardrobe; and
update the user database to indicate that the article has been one of placed in and removed from the user's wardrobe.

18. A system according to claim 15, wherein the program of instructions stored in memory of the server causing the server processor to receive from the user mobile device at least one characteristic of an article in the user's wardrobe further causes the server processor to receive one of a barcode scan and text entry from the user mobile device.

19. A system according to claim 15, wherein the program of instructions stored in memory of the user mobile device causing the user mobile device processor to send at least one characteristic of an article in the user's wardrobe and to at least one of scan a barcode and send the barcode scan to the server, and receive a text entry by the user and send the text entry to the server.

20. A system according to claim 15, wherein the program of instructions stored in memory of the server causing the server processor to receive from the user mobile device at least one image of the article in the user's wardrobe further causes the server processor to receive from the user mobile device at least one image of the article captured by the image capture device.

21. A system according to claim 15, wherein the program of instructions stored in memory of the server causing the server processor to identify the article further causes the server processor to classify the article and compare the classification of the article with at least one other article in a reference database with the same classification.

22. A system according to claim 21, wherein the program of instructions stored in memory of the server causing the server processor to classify the article further causes the server processor to estimate an articulated pose of the clothing item of interest, segment the image of the article of interest, cluster the segments, and analyze the clustered segments to determine whether any of the clustered segments correspond to a clothing class.

23. A system according to claim 22, wherein the segments are clustered using Approximate Gaussian Mixture clustering.

24. A system according to claim 15, wherein the at least one characteristic comprises at least one of size, color, brand, material, type of article, purchase date and user supplied text.

25. A system according to claim 15, wherein the program of instructions stored in memory of the server causing the server processor to identify the article further causes the server processor to compare one of the at least one characteristic with at least one entry in a reference database having a plurality of entries for a plurality of articles, and identify whether at least one of the at least one of the plurality of articles has the same characteristic as the at least one characteristic.

26. A system according to claim 16, wherein the at least one criteria comprises at least one of day, event, weather, fays, color, holiday, type, vacation and fashion.

27. A system according to claim 17, wherein the program of instructions stored in memory of the server causing the server processor to receive from the user mobile device an input indicating that an article has been one of removed from and replaced in the user's wardrobe, identify the article that has been one of removed from and replaced, and update the user database to indicate the article has been one of removed and replaced, further causes the server processor to receive a signal from the user mobile device indicating that an article has been removed from the wardrobe, the signal containing an identifier for the article, wherein the server processor searches the database record for the user's wardrobe to determine if it contains the identifier for the article and, if it does, update that entry to indicate the article has been removed.
